(19) United States
(12) Patent Application Publication
(10) Pub. No.: US 2017/0151662 A1
(43) Pub. Date: Jun. 1, 2017

(54) Floating hand tool

(71) Applicant: Chris Urbanek, Clearwater, FL (US)

(72) Inventor: Chris Urbanek, Clearwater, FL (US)

(21) Appl. No.: 15/431,702

(22) Filed: Feb. 13, 2017

Related U.S. Application Data
(60) Provisional application No. 62/095,040, filed on Dec. 21, 2014.

(51) Int. Cl. B25G 1/10; B25B 23/16

(52) U.S. Cl. CPC B25G 1/102; B25B 23/16

(57) ABSTRACT

The invention is directed to a floating hand tool. The general purpose of the present invention, which will be described subsequently in greater detail, is to provide a hand tool that floats in water. The tool contains handle made of a floatable material. The floatable handle replaces the grip on ratchets, screw drivers, and any hand tool used in water with floatable grips. The features of the invention which are believed to be novel are particularly pointed out and distinctly claimed in the concluding portion of the specification. These and other features, aspects, and advantages of the present invention will become better understood with reference to the following drawings and detailed description.

### CROSS-REFERENCE TO RELATED APPLICATIONS

This Application claims the benefit of U.S. Provisional Application No. 62/095,040, filed Feb. 13, 2016, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to the field of hand-tool devices and more specifically relates to a floating hand tool that floats in water. The tool provides a handle manufactured from a material which floats in water. The floatable handle replaces the grip on ratchets, screw drivers, and any hand tool which may used in the water with floatable grips.

A hand tool is any tool that is not a power tool—that is, one powered by hand rather than by a motor or engine. Some examples of hand tools are garden forks, secateurs, rakes, hammers, spanners, pliers, screwdrivers and chisels. Hand tools are generally less dangerous than power tools.

A search of the prior art reveals various hand tools and associated devices which have been developed to provide means to solve problems found in floatable hand-tool devices art. None are closely related to the present invention, but several include features which resemble those of the present invention. Each has proven to be less than satisfactory in its own way.

Method and apparatus for enabling hand tools to float, U.S. Pat. No. 6,726,516 (priority Dec. 27, 2001), provides a grip comprising a tubular sleeve which is placed over a handle or pre-existing tool grip and enables the tool to float grip side up, thereby allowing the tool to be easily seen and retrieved. The grip may have varying thicknesses and diameters and may be colored or treated with a luminescent or reflective coating so as to be easily seen. The grip material may also be selected so that it molds to the user's hand during use.

Buoyant hand tool, U.S. Pat. No. 6,877,405 (priority Jan. 3, 2003), provides a non-conductive, substantially buoyant-in-water hand tool comprising an elongated handle portion formed of non-corrosive, non-conductive material having a density greater than water and an elongated working tool connected to and extending axially from a proximal end of said handle portion. The handle portion has one or more outwardly opening cavities formed into a side surface of the handle portion. An elongated tubular sheath formed of material buoyant in water covers and seals, encloses, and forms one or more airtight cavities whereby the effective density of the hand tool is less than that of water.

Floatable hand tool, U.S. Pat. No. 7,272,997 (filed Apr. 24, 2006), provides a shank having an inner wall formed with an axially extending through hole, and a tool tip mounted on an end of the shank and having an end portion provided with a protruding connecting rod inserted into the through hole of the shank so that the through hole of the shank forms a closed chamber. Thus, the floatable hand tool floats on the water level by the floating force produced by the closed chamber formed by the through hole of the shank. In addition, the floatable hand tool floats on the water level, thereby preventing the floatable hand tool from being missed when falling into the water, and thereby facilitating a user operating the floatable hand tool in the water.

Floating, non-conductive hand tools, U.S. Pat. No. 5,865,077 (filed Sep. 27, 1996), provides floating, non-conductive hand tool such as pliers or channel locks for use by those working proximate to water or an electrical source. The tools are extremely durable, lightweight, and have an internal cavity capable of holding a gas or a light weight polymer foam material to substantially reduce the overall density of the hand tool. Alternatively, the handle ends of the tool may be encased with a low density sheathing material, used either independently or in conjunction with the aforementioned internal cavity to reduce the density of the tool.

Some of the prior art inventions present certain disadvantages. The present invention has been developed for the purpose of addressing and resolving these disadvantages. A floating hand tool that floats in water, which provides a handle manufactured from a material which floats in water, would resolve these problems.

### SUMMARY OF THE INVENTION

Accordingly, the invention is directed to a floating hand tool. The general purpose of the present invention, which will be described subsequently in greater detail, is to provide a hand tool that floats in water. The tool contains handle made of a floatable material. The floatable handle replaces the grip on ratchets, screw drivers, and any hand tool used in water with floatable grips. The features of the invention which are believed to be novel are particularly pointed out and distinctly claimed in the concluding portion of the specification. These and other features, aspects, and advantages of the present invention will become better understood with reference to the following drawings and detailed description.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a side cutaway view of the first exemplary embodiment, displaying the handle 10, the interior space 11, and the endcap 12.

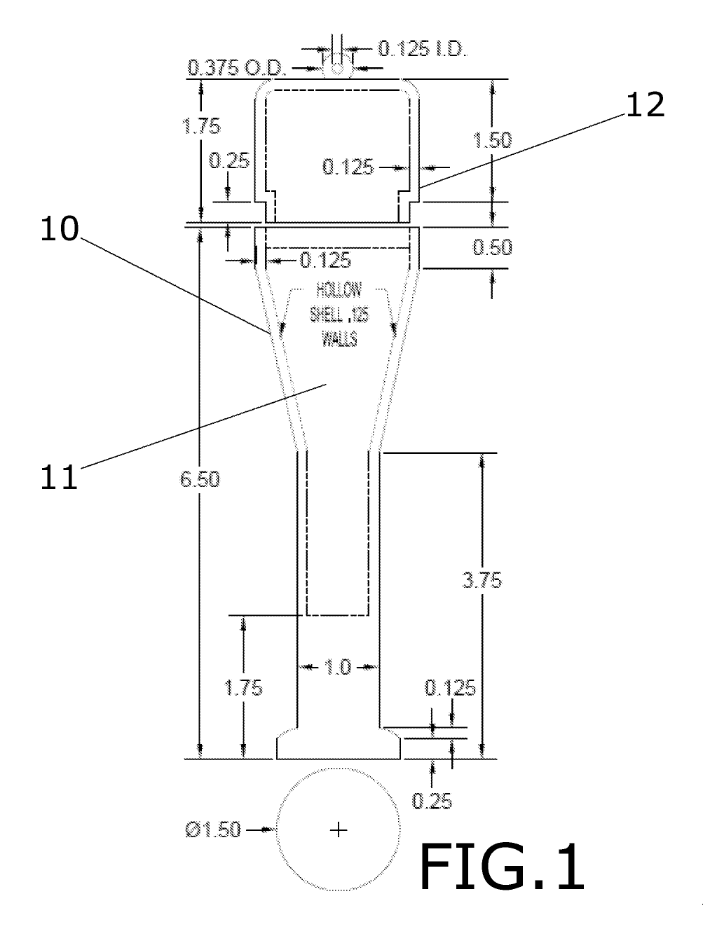

FIG. 2 is a side cutaway view of the first exemplary embodiment with the endcap removed, displaying the handle 10, the interior space 11, and the endcap 12.

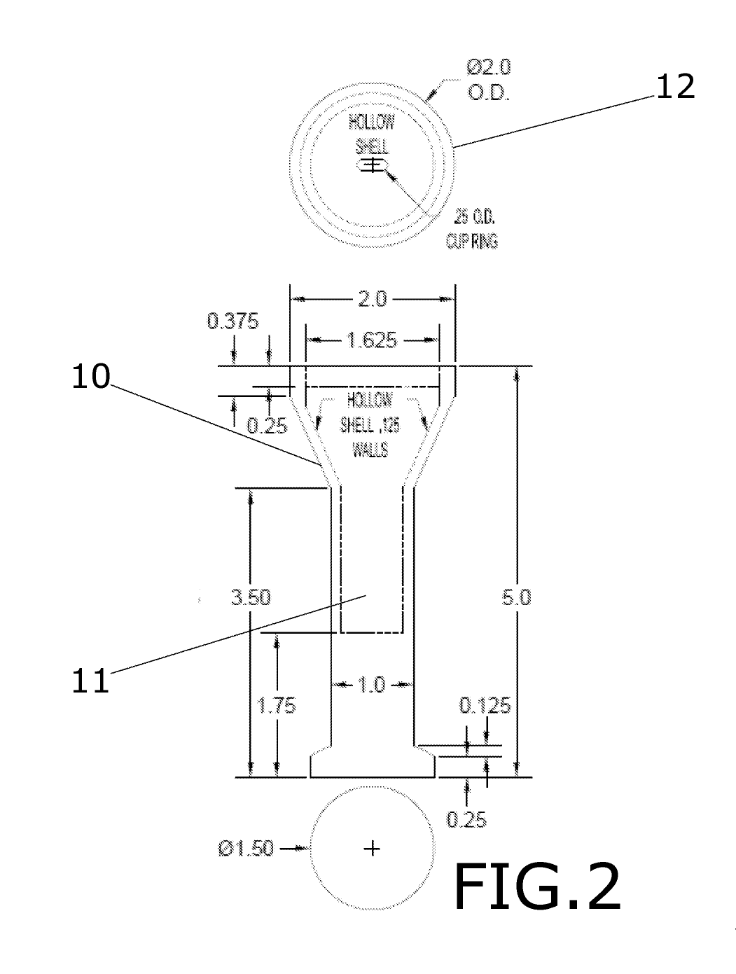

### DETAILED DESCRIPTION OF THE INVENTION

Referring now to the invention in more detail, the invention is directed to a floating hand tool.

The first exemplary embodiment is comprised of a hand tool, such as a screwdriver or crescent wrench, which is similar in structure and function to a conventional hand tool of the same type, with the following modifications. The handle 10 is hollow and roughly cylindrical, providing sufficient volume for a large interior space 11 for flotation purposes. The lower end of the handle 10 tapers slightly and is preferably affixed to the shaft of the hand tool with epoxy or a similar adhesive. The upper end of the handle 10 provides a removable endcap 12, which is preferably affixed to the handle 10 with screw threads and creates a watertight seal when affixed to the handle 10.

The first exemplary embodiment comprises a floatable handle 10 that replaces grips on hand tools such as ratchet wrenches, crescent wrenches, and screwdrivers which are used in water. The surface of the handle 10 conforms to a hand of a user, thereby increasing comfort when in use.

A primary benefit of the present invention is if a tool is dropped in water, the handle 10 will cause the tool to float, thereby leading to a fast recovery of the hand tool. The present invention is ideal for boat owners or for anyone who works around water.

To use the first exemplary embodiment, the user may grasp the handle 10 and use the tool in the same manner as a conventional tool.

The handle 10 is preferably manufactured from rigid, durable materials which are relatively low density, such as high-impact plastic or aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A floating device for hand-tool devices when working around a water environment, the device comprising: floatable handles that replace hand-grips on hand-tools.

2. The device of claim 1, wherein the floatable handles are coupled to the hand-tools via an epoxy resin.

3. The device of claim 1, wherein the hand-tools includes ratchets, screwdrivers, and wrenches used in the aquatic environment.

4. The device of claim 1, wherein the hand-grips conform to a hand of a user to increase comfort when the hand-tools are in use.

5. The device of claim 1, wherein the floatable handles are made of high-impact plastic, aluminum alloy, polystyrene, fiberglass, balsa wood, aerogel with helium, polyethylene composite, and the like.

6. The device of claim 1, wherein the floatable handles are made of high-impact plastic, aluminum alloy, polystyrene, fiberglass, balsa wood, aerogel with helium, polyethylene composite, and the like, and any combinations thereof wherein the weight of a hand-tool plus floatable handles has a reserve buoyancy such that the weight of the hand-tool is greater than a weight of water that it displaces.

7. The device of claim 1, comprising additional features or options as essentially described herein.
